(19) United States
(12) Patent Application Publication
(10) Pub. No.: US 2022/0116512 A1
(43) Pub. Date: Apr. 14, 2022

(54) ELECTRONIC DOCUMENT MANAGING APPARATUS, IMAGE FORMING APPARATUS, AND STORAGE MEDIUM

(71) Applicant: KONICA MINOLTA, INC., Tokyo (JP)

(72) Inventor: Kosuke MASUMOTO, Tokyo (JP)

(73) Assignee: KONICA MINOLTA, INC., Tokyo (JP)

(21) Appl. No.: 17/473,287

(22) Filed: Sep. 13, 2021

(30) Foreign Application Priority Data
Oct. 8, 2020 (JP) 2020-170222

(51) Int. Cl. H04N 1/32

(52) U.S. Cl. CPC H04N 1/32229; H04N 1/32352

(57) ABSTRACT

An electronic document managing apparatus for managing an electronic document includes a hardware processor. The hardware processor obtains the electronic document and manages an approval state of the obtained electronic document. In response to receiving an instruction to output the electronic document, the hardware processor refers to the approval state. The hardware processor permits the output of an approved electronic document only when all of a predesignated approver has approved the electronic document, the approved electronic document being the electronic document bearing a seal image of all of the approver. The hardware processor does not permit the output of the electronic document bearing any of the seal image when any of the approver has not approved the electronic document yet.

### CROSS-REFERENCE TO RELATED APPLICATIONS

The entire disclosure of Japanese Patent Application No. 2020-170222 filed on Oct. 8, 2020 is incorporated herein by reference in its entirety.

### BACKGROUND

### Technological Field

The present disclosure relates to an electronic document managing apparatus, an image forming apparatus, and a storage medium.

### Description of Related Art

Electronic documents (digitized documents) have been utilized more often in processes conventionally performed with physical paper documents, along with the development of networks (e.g., the Internet). With the increase of use of electronic documents, JP2004-145618A discloses an information processing apparatus for electronic documents. The apparatus puts electronic seals that allow users to easily check who actually makes a modification on the electronic document and who has approved the electronic document, while the electronic document is being passed among several people over the network.

### SUMMARY

The information processing apparatus, however, puts electronic seals on the electronic document that has not been fully approved yet. When a user outputs the half-approved electronic document for check or modification, the apparatus outputs the electronic document that bears seals of part of the users who have approved the document. The other user may mistake the output document for the formal document that bears all the required electronic seals. Accordingly, the document may be handled without obtaining all required approvals, which may generate unwanted handling work.

The present invention has been made in view of above issues. Objects of the present invention include providing an electronic document managing apparatus, an image forming apparatus, and a storage medium that can prevent users from mistaking half-approved electronic documents for fully-approved electronic documents.

To achieve at least one of the abovementioned objects, according to an aspect of the present invention, there is provided an electronic document managing apparatus for managing an electronic document, including a hardware processor that obtains the electronic document and manages an approval state of the obtained electronic document, wherein in response to receiving an instruction to output the electronic document, the hardware processor refers to the approval state and

permits the output of an approved electronic document only when all of a predesignated approver has approved the electronic document, the approved electronic document being the electronic document bearing a seal image of all of the approver and

does not permit the output of the electronic document bearing any of the seal image when any of the approver has not approved the electronic document yet.

According to another aspect of the present invention, there is provided an electronic document managing apparatus for managing an electronic document, including a hardware processor that obtains the electronic document and manages an approval state of the obtained electronic document, wherein in response to receiving an instruction to output the electronic document in full color, the hardware processor refers to the approval state and

permits output of an approved electronic document in full color only when all of a predesignated approver has approved the electronic document, the approved electronic document being the electronic document bearing a seal image of all of the approver, and

permits output of the electronic document in monochrome that bears the seal image of the approver having approved the electronic document when any of the predesignated approver has not approved the electronic document yet.

According to another aspect of the present invention, there is provided a non-transitory computer-readable storage medium storing a program that causes a computer of an electronic document managing apparatus to:

obtain the electronic document;

manage an approval state of the obtained electronic document;

refer to the approval state in response to receiving an instruction to output the electronic document and
permit the output of an approved electronic document only when all of a predesignated approver has approved the electronic document, the approved electronic document being the electronic document bearing a seal image of all of the approver and
not permit the output of the electronic document bearing any of the seal image when any of the approver has not approved the electronic document yet.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a block diagram of an electronic document managing apparatus according to an embodiment and other apparatuses related to an electronic document outputting process;

FIG. 2 is a flowchart of the electronic document outputting process according to the embodiment;

FIG. 3A is an example of an electronic document according to the embodiment;

FIG. 3B is an example of a fully-approved electronic document;

FIG. 4A to FIG. 4E show examples of an approval section in which an approval image is formed;

FIG. 4F is an example of a half-approved electronic document on which a watermark is formed; and

FIG. 5 is a flowchart of the electronic document outputting process according to a modification.

### DESCRIPTION OF EMBODIMENTS

[Overall Configuration]

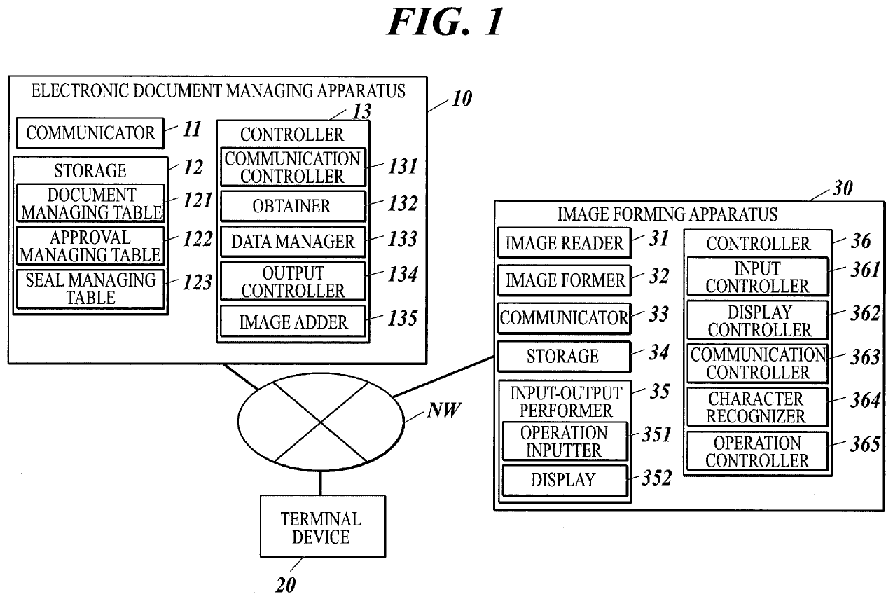

FIG. 1 is a block diagram of an electronic document managing apparatus 10 according to this embodiment and other apparatuses related to an electronic document outputting process. As shown in FIG. 1, the electronic document managing apparatus 10 is connected to a terminal device 20 and an image forming apparatus 30 over a network NW so as to communicate with each other.

The network NW may be, for example, the Internet or an intranet that allows the electronic document managing apparatus 10, the terminal device 20, and the image forming apparatus 30 to connect to each other. These apparatuses may be connected to the network NW through a wired or wireless connection.

Although FIG. 1 shows a single electronic document managing apparatus 10, a single terminal device 20, and a single image forming apparatus 30 connected to the network NW, the number of these apparatuses may be determined as desired. Further, the apparatuses connected to the network NW are not limited to the abovementioned apparatuses.

[Electronic Document Managing Apparatus]

The electronic document managing apparatus 10 is, for example, a server computer and includes a communicator 11, a storage 12, and a controller 13 (hardware processor). The electronic document managing apparatus 10 mainly manages an electronic document(s) D, approval information of the electronic document D and permission to output a fully-approved electronic document AD. The fully-approved electronic document AD is the electronic document D added with seal images S. When the electronic document managing apparatus 10 is a server computer, the electronic document managing apparatus 10 may be a cloud server provided in the cloud or an on-premises server as a physical device.

The communicator 11 includes a communication integrated circuit (IC) and a communication connecter. The communicator 11 performs network communication over the network NW by using various communication protocols, such as the transmission control protocol (TCP) or the internet protocol (IP), to send and receive various kinds of data to and from desired apparatuses, such as the terminal device 20, the image forming apparatus 30, and other computers (not shown).

The storage 12 consists of a read-only memory (ROM), which is a nonvolatile semiconductor memory, and/or a hard disk drive (HDD), which is a nonvolatile storage.

The storage 12 stores various kinds of data related to the electronic document outputting process. More specifically, a database is structured in the storage 12. The database includes: file data of the electronic document D registered to the electronic document managing apparatus 10; a document managing table 121 for managing information on the electronic document D; an approval managing table 122; and a seal managing table 123. The approval managing table 122 manages approval information on approvers of the electronic document D, whether the approvers have approved the electronic document D (approval state), and date and time when the electronic document is fully approved. The seal managing table 123 manages seal images S of the respective users.

The controller 13 is configured as a computer system that includes a central processing unit (CPU) and any type of semiconductor memory (random access memory: RAM). The CPU executes a predetermined program to perform various kinds of processing. More specifically, the electronic document managing apparatus 10 has a specific operating system (OS) and can perform multiple programs using the OS. The controller 13 thus functions as various kinds of processors including a communication controller 131, an obtainer 132, a data manager 133, an output controller 134, and an image adder 135. The programs may be installed in the electronic document managing apparatus 10 via a portable storage medium, such as a universal serial bus (USB) memory, or via the network NW.

The communication controller 131 is a processor that controls, in cooperation with the communicator 11, communications with external apparatuses including the terminal device 20 and the image forming apparatus 30.

The obtainer 132 is a processor that performs a document-obtaining process of obtaining the electronic document D sent to the electronic document managing apparatus 10 from the terminal device 20 or the image forming apparatus 30.

The data manager 133 is a processor that performs a registration of various kinds of data to the storage 12 and a data-obtaining process of obtaining various kinds of data from the storage 12. For example, the data manager 133 registers the electronic document D obtained by the obtainer 132 to the document managing table 121 and obtains approval information of the electronic document D registered to the approval managing table 122.

The output controller 134 is a processor that determines whether or not to permit the output of the electronic document D. More specifically, when instructed by the terminal device 20 to output the electronic document D, the data manager 133 refers to the approval information of the electronic document D obtained from the approval managing table 122. The output controller 134 permits the output of the fully-approved electronic document AD only when all of the predesignated approvers have approved the document. The output controller 13 does not permit the output of the electronic document D that bears the seal image(s) S when any of all of the approvers has not approved the document yet.

The approvers of the electronic document D may be designated manually by a user when the user sends the electronic document D, for example. Alternatively, the approvers of the electronic document D may be designated automatically by the data manager 133. More specifically, when the obtainer 132 obtains the electronic document D as text data, the data manager 133 may obtain information on the type of the electronic document D (e.g., draft proposal submitted for endorsement, invoice) and the amount of money written thereon from the text data, and may automatically designate the approvers on the basis of the obtained information and a predetermined approver table (not shown).

The image adder 135 is a processor that adds seal images S to the electronic document D. More specifically, in response to the permission by the output controller 134 to output the fully-approved electronic document AD, the image adder 135 adds the seal image(s) S to the electronic document D, which is electronic data, thereby creating electronic data of the fully-approved electronic document AD. The seal image S is obtained by the data manager 133 from the seal managing table 123. When part of the predesignated approvers has approved the electronic document D, the image adder 135 adds an approval image(s) I to the electronic document D, thereby creating electronic data of the half-approved electronic document PD. The approval image I indicates that part of the approvers have approved the electronic document D.

(Terminal Device)

The terminal device 20 is possessed and used by the user to instruct the electronic document outputting process. The terminal device 20 is, for example, a client personal computer (PC) placed at a certain place or a portable device (e.g., smartphone) that can be carried by the user. In the terminal device 20, an application or a Web browser is installed for displaying a window to which a request to the electronic document managing apparatus 10 is input. Through the window, the user performs various operations, such as registration and approval of the electronic document D and instruction to output the electronic document D over the network NW.

(Image Forming Apparatus)

The image forming apparatus 30 outputs the electronic document D, the half-approved electronic document PD, and fully-approved electronic document AD on sheets of paper or other media in response to the permission by the controller 134 of the electronic document managing apparatus 10. The image forming apparatus 30 includes an image reader 31, an image former 32, a communicator 33, a storage 34, an input-output performer 35, and a controller 36. The image forming apparatus 30 causes these components to operate in combination with each other to perform various processes.

More specifically, the image forming apparatus 30 may be a multi-functional peripheral (MFP) that has functions of scanning, copying, faxing, e-mailing, and a print output but is not limited thereto. The image forming apparatus 30 at least has a print output function.

The image reader 31 includes an automatic document feeder (ADF), a platen glass, and an optical system. The image reader 31 reads, using the optical system, images on one side or both sides of a physical document placed on the ADF or on the platen glass; reads reflected light using a linear image sensor to obtain image signals; and performs processing on the image signals (e.g., A/D conversion, shading correction, compression). The image reader 31 thus serves as a scanner for obtaining image data (electronic document D) of the physical document.

The image former 32 forms images on sheets of paper or other media on the basis of image data to be printed and output. The image former 32 thus performs copying and printout.

The communicator 33 sends and receives various kinds of data to and from desired apparatuses including the electronic document managing apparatus 10 and the terminal device 20 over the network, thereby performing various functions. For example, the communicator 33 sends and receives image data to and from other not-shown facsimile devices via a facsimile line (faxing function). The communicator 33 also sends and receives image data to and from the terminal device 20 using emails over the network NW (emailing function). The communicator 33 also sends image data of the document read by the image reader 31 to the electronic document managing apparatus 10, thereby performing registration of the electronic document D.

The storage 34 consists of a HDD, for example and stores data including print job data for printout instructions.

The input-output performer 35 includes an operation inputter 351 that receives inputs to the image forming apparatus 30 and a display 352 that displays (outputs) various kinds of information. The display 352 consists of an organic electroluminescence display or a liquid crystal display (LCD) provided with a pressure-sensitive touchscreen constituted of latticed transparent electrodes.

The display 352 displays various windows (e.g., guidance window) and messages related to execution of jobs for the user. The display 352 displays images of operation buttons for touch operations and receives the touch operations by the user. The input operations are converted into operation signals and output to the controller 36.

The controller 36 includes a CPU and any kind of semiconductor memory, as with the controller 13 in the electronic document managing apparatus 10. The controller 36 executes predetermined software programs with the mounted OS, thereby serving as various processors, such as an input controller 361, a display controller 362, a communication controller 363, a character recognizer 364, and an operation controller 365.

The input controller 361 is a processor that controls inputs to the image forming apparatus 30 in cooperation with the operation inputter 351.

The display controller 362 is a processor that controls the display output operation of the display 352.

The communication controller 363 is a processor that controls communications with external apparatuses in cooperation with the communicator 33.

The character recognizer 364 is a processor that performs character recognition processing on image data of the read document in cooperation with the image reader 31 and converts the recognized information into text data. The operation controller 365 is a processor that controls various job operations of the image forming apparatus 30, such as scanning job, copying job, printout job, and communication job.

[Operation]

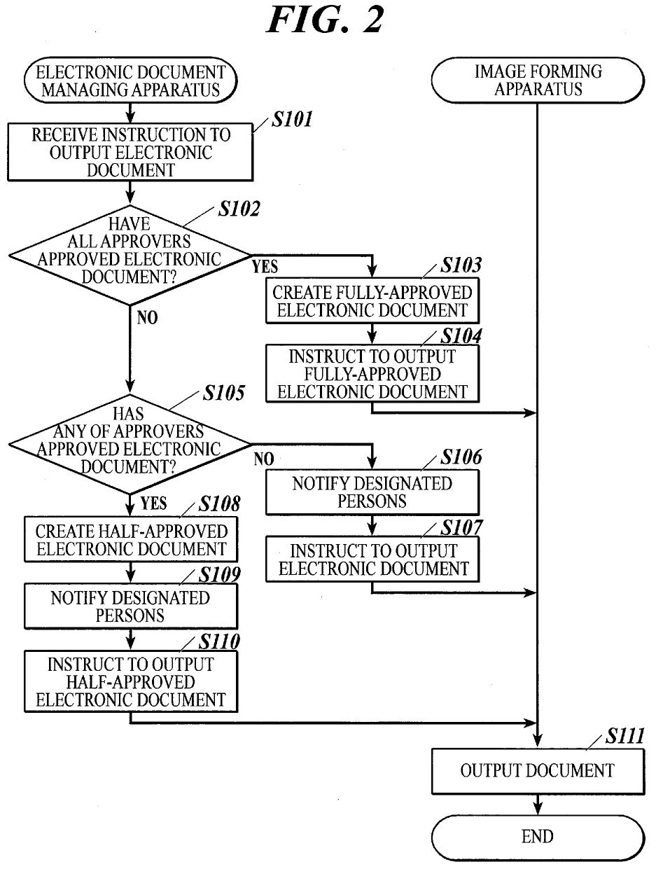

Hereinafter, the electronic document outputting process by the electronic document managing apparatus 10 in this embodiment is described in detail with reference to the flowchart in FIG. 2.

In this embodiment, the user of the terminal device 20 causes the electronic document managing apparatus 10 to perform processing for outputting the electronic document D. The electronic document outputting process starts when, for example, the user activates an electronic document management application or inputs the address of the electronic document managing apparatus 10, which controls the flow of the process, in the Web browser and logs-in.

First, the user selects, on the electronic document managing window displayed on the terminal device 20, the electronic document D to be output and instructs the electronic document managing apparatus 10 to output the selected electronic document D. The electronic document D receives the instruction for output (Step S101).

The electronic document D may be created with the terminal device 20 and registered to the electronic document managing apparatus 10, for example. Alternatively, the electronic document D may be image data converted from a physical document by the image reader 31 of the image forming apparatus 30 or text data converted from a physical document by the character recognizer 364. The electronic document D as the image data/text data is sent to the electronic document managing apparatus 10 by the communicator 33 and registered.

When receiving the instruction to output the electronic document D from the terminal device 20, the output controller 134 instructs the data manager 133 to obtain the approval state of the electronic document D from the approval managing table 122. On the basis of the obtained approval state, the output controller 134 determines whether all of the approvers designated beforehand have approved the electronic document D (Step S102).

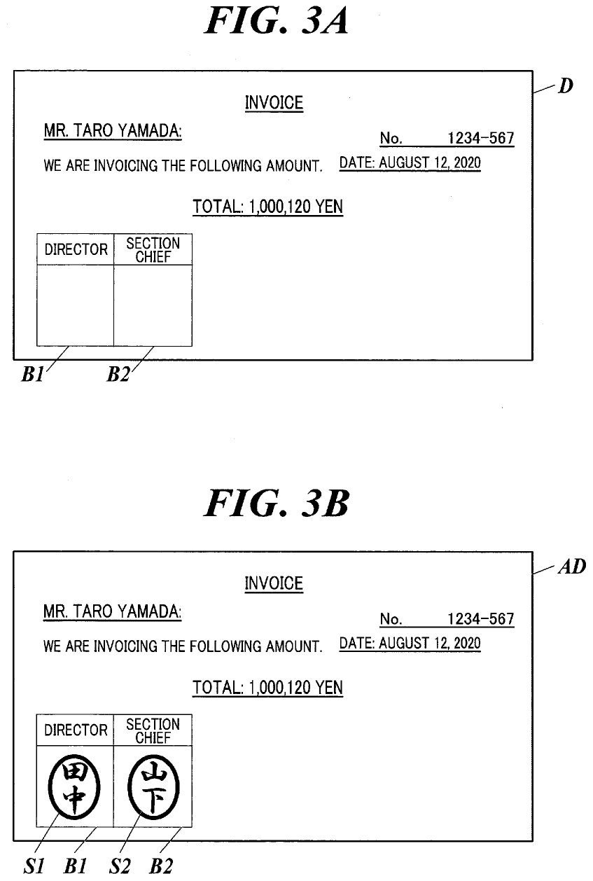

When determining that all of the approvers designated beforehand have approved the electronic document D (Step S102: YES), the output controller 134 permits output of the fully-approved electronic document AD and causes the image adder 135 to create the fully-approved electronic document AD (Step S103). As shown in FIG. 3B, the fully-approved electronic document AD has seal images S1, S2 of all the designated approvers in the approval sections B1, B2 of the electronic document D (FIG. 3A).

After the fully-approved electronic document AD is ready, the output controller 134 instructs, via the communication controller 131, the image forming apparatus 30 to output the fully-approved electronic document AD (Step S104). When receiving the fully-approved electronic document AD and the instruction to output the fully-approved electronic document AD from the electronic document managing apparatus 10, the image forming apparatus 30 outputs the fully-approved electronic document AD (Step S111). The electronic document outputting process ends.

When determining that all of the approvers designated beforehand have not approved the electronic document D yet (Step S102: NO), the output controller 134 determines whether any of the designated approvers has approved the electronic document D (Step S105).

When determining that none of the approvers designated beforehand have approved the electronic document D (Step S105: NO), the output controller 134 does not permit output of the fully-approved electronic document AD, which is the electronic document D bearing seal images S of all of the approvers. Instead, the output controller 134 permits output of the electronic document D that does not bear seal images S or approval images I, as shown in FIG. 3A. The communication controller 131 notifies, with the communicator 11 as the notifier, persons designated beforehand that the electronic document D is to be output (Step S106). The persons are among the approvers designated beforehand or a person that created the electronic document D.

The method for notifying the designated persons may be an appropriate known method, such as displaying a notification on the electronic document managing window or sending emails to e-mail addresses of the persons registered beforehand.

After notifying that the electronic document D is to be output, the output controller 134 instructs the image forming apparatus 30 to output the electronic document D (Step S107). When receiving the electronic document D and the instruction to output the electronic document D from the electronic document managing apparatus 10, the image forming apparatus 30 outputs the electronic document D (Step S111). The electronic document outputting process ends.

When determining that any of the designated approvers has approved the electronic document D (Step S105: YES), the output controller 134 does not permit output of the fully-approved electronic document AD that bears seal images S of all of the approvers. Instead, the output controller 134 permits output of a half-approved electronic document PD and causes the image adder 135 to create the half-approved electronic document PD (Step S108). The half-approved electronic document PD is the electronic document D bearing an approval image I that indicates that part of the approvers have approved the electronic document D.

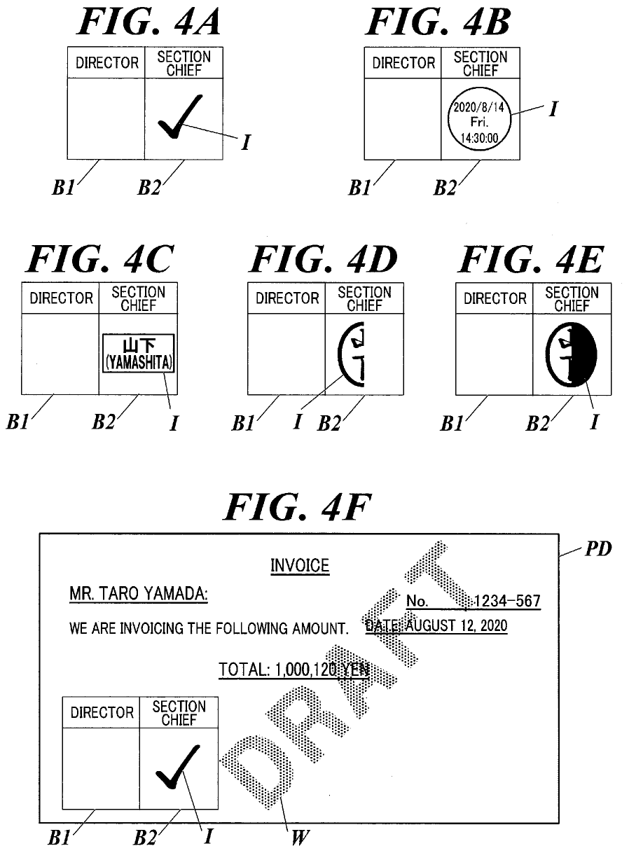

More specifically, assume that there are two approvers of the electronic document D, director and section chief. When only the section chief has approved the electronic document D, the output controller 134 causes the image adder 135 to create the half-approved electronic document PD. As shown in FIG. 4A, the half-approved electronic document PD is the electronic document D that bears the checkmark as the approval image I in the approval section B2 for the section chief, who has already approved the electronic document D.

The approval image I is not limited to the checkmark shown in FIG. 4A. The approval image I may be different from the seal image S to be added to the approval section B. For example, the approval image I may be a bullet, an image of the approved date and time of the approver as shown in FIG. 4B, an image of the name of the approver that is different from the seal image S as shown in FIG. 4C, a half seal image as shown in FIG. 4D, or a seal image part of which is painted out as shown in FIG. 4E.

The positions of the seal image S and the approval image I may be designated as desired by a person who registers the electronic document D in registering the electronic document D or by an approver of the electronic document D in approving the electronic document D. The positions of the seal image S and the approval image I may also be automatically determined on the basis of image data or text data of the electronic document D when the data manager 133 registers the electronic document D to the document managing table 121. The position to which the approval image I is added is therefore not limited to the inside of the approval section B but may be in the margin of the electronic document D (e.g., header or footer).

In addition to the approval image I, the half-approved electronic document PD may include a watermark W indicating that the electronic document D is half-approved, as shown in FIG. 4F.

Which approval image I is added to the half-approved electronic document PD and whether the watermark W is formed on the half-approved electronic document PD is set to the image adder 135 beforehand. The setting, however, may be changed by the user as desired with the terminal device 20.

Further, the number of types of approval images I to be added to the half-approved electronic document PD is not limited to one. When there are multiple approvers who have approved the electronic document D, these approvers may use different approval images I.

When the half-approved electronic document PD is ready, the output controller 134 notifies, as with Step S106, persons designated beforehand that the half-approved electronic document PD is to be output (Step S109).

After notifying that the half-approved electronic document PD is to be output, the output controller 134 instructs the image forming apparatus 30 to output the half-approved electronic document PD (Step S110). When receiving the half-approved electronic document PD and the instruction to output the half-approved electronic document PD from the electronic document managing apparatus 10, the image forming apparatus 30 outputs the half-approved electronic document PD (Step S111). The electronic document outputting process ends.

According to the above embodiment, the electronic document managing apparatus 10 for managing the electronic document D includes: the obtainer 132 that obtains the electronic document D; the data manager 133 that manages an approval state of the obtained electronic document D; and the output controller 134 that refers to the approval state in response to receiving an instruction to output the electronic document D. The output controller 134 permits output of the fully-approved electronic document AD that bears seal images S of all of the approvers only when all of predesignated approvers have approved the electronic document D, whereas the output controller 134 does not permit output of the electronic document D that bears bearing any of the seal images S when any of the approvers has not approved the electronic document D yet.

The electronic document managing apparatus 10 therefore can prevent users from mistaking the electronic document that has not been approved yet for the fully-approved electronic document.

Further, when part of the predesignated approvers has approved the electronic document D, the image adder 135 creates the half-approved electronic document PD, and the output controller 134 permits output of the half-approved electronic document PD. The half-approved electronic document PD is the electronic document D bearing the approval image I indicating that part of the approvers has approved the electronic document D.

Thus, the electronic document managing apparatus 10 can prevent users from mistaking the electronic document that has not been approved yet for the fully-approved electronic document. The electronic document managing apparatus 10 can also notify who has already approved the electronic document D among the approvers.

Further, the electronic document managing apparatus 10 may further include the communicator 11 (notifier). In response to the half-approved electronic document PD being output, the communicator 11 sends a notification to a predetermined person that is among a person that prepared the electronic document and the approvers.

This can further reduce the possibility that the electronic document having not been approved yet is mistaken for the fully-approved electronic document.

Although the electronic document outputting process using the electronic document managing apparatus 10 according to the embodiment of the present invention has been described, the above-described embodiment does not limit the present invention and may be variously modified within the scope of the present invention.

For example, assume that part of approvers among approvers designated beforehand has approved the electronic document and that the terminal device 20 gives the instruction to output the electronic document in full color. In the case, the electronic document managing apparatus 10 may instruct the image forming apparatus 30 to output the black-and-white electronic document that bears the seal images S of the part of approvers.

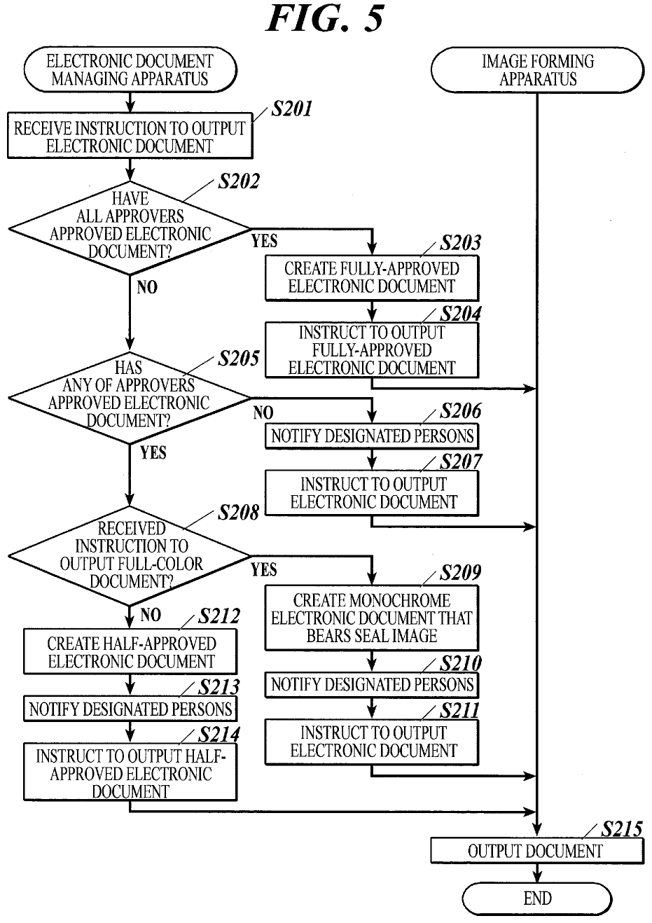

Hereinafter, operation of the electronic document managing apparatus 10 in a modification is described with reference to the flowchart in FIG. 5. The modification includes a process to output the black-and-white electronic document D that bears the seal images S of the part of approvers.

The process from Step S201 to S207 is not described because the process is the same as the process from Step S101 to S107 in FIG. 2.

When determining that part of the approvers designated beforehand has approved the electronic document D (Step S205: YES), the output controller 134 determines whether an instruction to output the electronic document D in full-color is received from the terminal device 20 (Step S208).

When determining that an instruction to output the electronic document D in full-color is received (Step S208: YES), the output controller 134 permits output of the black-and-white electronic document D that bears the seal images S of the part of the approvers having already approved the electronic document D, and causes the image adder 135 to create the black-and-white electronic document D (Step S209).

When the electronic document D is ready, the output controller 134 notifies, as with Step S206, persons designated beforehand that the electronic document D is to be output (Step S210).

After notifying that the electronic document D is to be output, the output controller 134 instructs the image forming apparatus 30 to output the created electronic document D (Step S211). When receiving the electronic document D and the instruction to output the electronic document D from the electronic document managing apparatus 10, the image forming apparatus 30 outputs the electronic document D (Step S215). The electronic document outputting process ends.

The process from Step S212 to S214 is not described because it is the same as the process from Step S108 to S110 in FIG. 2.

In Step S209, although the image adder 135 creates the black-and-white electronic document D that bears the seal images S of the part of the approvers that has already approved the electronic document D, the present invention is not limited to this. In Step S209, the image adder 135 may create the electronic document D that bears the seal images S of the part of the approvers having approved the electronic document D, and in step S211, the image forming apparatus 30 may output the electronic document D in black and white colors.

In Steps S104, S107, S110, S204, S207, S211 and S214, the electronic document managing apparatus 10 instructs the image forming apparatus 30 to output the electronic document D, the half-approved electronic document PD, or the fully-approved electronic document AD. In Step S111 and S215, the image forming apparatus 30 prints and outputs the document. This example, however, does not limit the present invention. The documents may be output on the screen of the terminal device 20. More specifically, the user of the terminal device 20 may obtain the electronic document D, the half-approved electronic document PD, or the fully-approved electronic document AD from the electronic document managing apparatus 10 and causes the terminal device 20 to output the obtained document on its display.

Further, according to the above embodiment, the electronic document managing apparatus 10 includes: the obtainer 132 that obtains the electronic document D; the data manager 133 that manages the approval state of the obtained electronic document D; and the output controller 134 that permits, in receiving an instruction to output the electronic document D, output of the fully-approved electronic document D that bears seal images S of all of the approvers designated beforehand when all of the approvers have approved the electronic document D according to the approval state. The present invention, however, is not limited to this. The image forming apparatus 30 may have functions of the obtainer 132, the data manager 133, and the output controller 134.

Following is an example of the case where the image forming apparatus 30 has the functions of the obtainer 132, the data manager 133, and the output controller 134. The obtainer 132 obtains image data of the electronic document D with the image reader 31. The character recognizer 364 converts the image data into text data. The data manager 133 compares the text data and data stored in the document managing table 121. When there are data items that have the same document number, the output controller 134 causes the data manager 133 to obtain approval information of the electronic document D having the document number from the approval managing table 122. If all of the approvers have not yet approved the electronic document D, the output controller 134 may stop email and fax functions of the communicator 33 so as not to send the image data or the text data of the electronic document D to an external device.

Thus, the image forming apparatus 30 can prevent sending the electronic document D or the half-approved electronic document PD to other users. This can reduce a possibility that the other users mistake the obtained electronic document D/half-approved electronic document PD for the fully-approved electronic document AD.

What is claimed is:

1. An electronic document managing apparatus for managing an electronic document, comprising a hardware processor that obtains the electronic document and manages an approval state of the obtained electronic document, wherein in response to receiving an instruction to output the electronic document, the hardware processor refers to the approval state and
permits the output of an approved electronic document only when all of a predesignated approver has approved the electronic document, the approved electronic document being the electronic document bearing a seal image of all of the approver and
does not permit the output of the electronic document bearing any of the seal image when any of the approver has not approved the electronic document yet.

2. The electronic document managing apparatus according to claim 1, wherein
when part of the predesignated approver has approved the electronic document, the hardware processor creates a half-approved electronic document and permits output of the half-approved electronic document, the half-approved electronic document being the electronic document bearing an approval image indicating that part of the approver has approved the electronic document.

3. The electronic document managing apparatus according to claim 2, wherein
the approval image includes an image of a name of the approver that has approved the electronic document, the image of the name being different from the seal image.

4. The electronic document managing apparatus according to claim 2, wherein
the approval image includes an image indicating a date and time at which the approver approved the electronic document.

5. The electronic document managing apparatus according to claim 2, wherein
the approval image includes an image that is different from the seal image and that is added to an approval section of the electronic document.

6. The electronic document managing apparatus according to claim 2, wherein
the hardware processor forms a watermark on the half-approved electronic document so as to indicate that the half-approved electronic document has not been fully approved yet.

7. The electronic document managing apparatus according to claim 2, further comprising a notifier, wherein
in response to the half-approved electronic document being output, the notifier sends a notification to a predetermined person, the person being among a person that prepared the electronic document and the approver.

8. An electronic document managing apparatus for managing an electronic document, comprising a hardware processor that obtains the electronic document and manages an approval state of the obtained electronic document, wherein in response to receiving an instruction to output the electronic document in full color, the hardware processor refers to the approval state and
permits output of an approved electronic document in full color only when all of a predesignated approver has approved the electronic document, the approved electronic document being the electronic document bearing a seal image of all of the approver, and
permits output of the electronic document in monochrome that bears the seal image of the approver having approved the electronic document when any of the predesignated approver has not approved the electronic document yet.

9. An image forming apparatus comprising:
the electronic document managing apparatus according to claim 1; and
an image former that forms the approved electronic document on a sheet after the hardware processor permits the output of the approved electronic document.

10. The image forming apparatus according to claim 9, further comprising an image reader that scans an original to obtain the electronic document, wherein
the hardware processor obtains the electronic document obtained by the image reader.

11. A non-transitory computer-readable storage medium storing a program that causes a computer of an electronic document managing apparatus to:
obtain the electronic document;
manage an approval state of the obtained electronic document;
refer to the approval state in response to receiving an instruction to output the electronic document and
permit the output of an approved electronic document only when all of a predesignated approver has approved the electronic document, the approved electronic document being the electronic document bearing a seal image of all of the approver and
not permit the output of the electronic document bearing any of the seal image when any of the approver has not approved the electronic document yet.
